(19) United States
(12) Patent Application Publication
(10) Pub. No.: US 2025/0185801 A1
(43) Pub. Date: Jun. 12, 2025

(54) BRUSH MODULE, BRUSH CLEANING DEVICE, AND BRUSH CLEANING METHOD USING THE SAME

(71) Applicant: SAMSUNG ELECTRONICS CO., LTD., Suwon-si (KR)

(72) Inventors: Hyejin JANG, Suwon-si (KR); Donghoon KWON, Suwon-si (KR)

(73) Assignee: SAMSUNG ELECTRONICS CO., LTD., Suwon-si (KR)

(21) Appl. No.: 18/781,457

(22) Filed: Jul. 23, 2024

(30) Foreign Application Priority Data
Dec. 11, 2023 (KR) 10-2023-0178812

(51) Int. Cl. A46B 17/06; B08B 1/52

(52) U.S. Cl. CPC A46B 17/065; B08B 1/52

(57) ABSTRACT

A brush apparatus includes a core portion rotating around a length direction as an axis, a main body portion at least partially surrounding the core portion, a plurality of protrusion portions protruding from the main body portion, and a detection portion disposed in at least a part of the main body portion and the plurality of protrusion portions. The detection portion is formed of poly vinyl acetal (PVA) including detection components that react with ceria.

### CROSS-REFERENCE TO RELATED APPLICATIONS

This application claims benefit of priority under 35 U.S.C. § 119 to Korean Patent Application No. 10-2023-0178812, filed on Dec. 11, 2023, in the Korean Intellectual Property Office, the disclosure of which is incorporated by reference herein in its entirety.

### BACKGROUND

### 1. Field

The present disclosure relates generally to substrate cleaning processes, and more particularly, to a brush apparatus, a brush cleaning device, and a brush cleaning method using the brush cleaning device.

### 2. Description of Related Art

After a chemical mechanical polishing (CMP) process, a post-CMP cleaning process may need to be performed to remove residues of particles and/or organic materials on a substrate.

A poly vinyl acetal (PVA) brush with a cylindrical structure may be used to perform the post-CMP cleaning process on the substrate. However, during the process of cleaning the substrate, at least some of contaminant materials attached to the substrate may adhere and/or deposit on the brush, thereby contaminating the substrate.

To potentially prevent the reverse contamination of the substrate, the brush may be cleaned repeatedly using a brush cleaning device that may self-clean the brush, thereby potentially preventing reverse contamination of the substrate.

The degree of contamination of the brush may need to be measured in order to determine the timing of a brush replacement. Typically, the degree of contamination of the brush may be predicted by measuring the degradation state of a brush surface using a separate measuring device. Alternatively or additionally, the degree of contamination of the brush may be predicted by analyzing the amount of effluent released during the substrate cleaning process.

However, when the brush is contaminated with ceria, and the like, there may be no method with which to detect the contamination in advance, and thus, the use life-span of the brush may be unnecessarily limited. For example, there may be no choice but to uniformly set the usable period of the brush to the time before defects occurred due to reverse contamination of the substrate by ceria.

In addition, when the expected use life-span of the brush is different depending on various process variables, such as, but not limited to, each process condition, process environment, and changes in the material or characteristic of the brush, there may be an inconvenience in resetting the use life-span of the brush according to each process.

In addition, since the degree of contamination of the brush is not measured quantitatively, it may not be possible to consider cases where the life-span of the brush is shortened due to unexpected variables that may occur in each process, thus making management difficult due to contamination of the brush.

### SUMMARY

One or more example embodiments of the present disclosure provide a brush apparatus in which a detection portion containing a detection component reacting with ceria is disposed in a part that is in contact with a substrate and changes a color when a brush is contaminated by ceria, and senses a color change of the detection portion by a brush cleaning device detection portion to quantitatively measure contamination on a surface of the brush due to ceria, a brush cleaning device, and a brush cleaning method of the brush cleaning device.

According to an aspect of the present disclosure, a brush apparatus includes a core portion rotating around a length direction as an axis, a main body portion at least partially surrounding the core portion, a plurality of protrusion portions protruding from the main body portion, and a detection portion disposed in at least a part of the main body portion and the plurality of protrusion portions. The detection portion is formed of poly vinyl acetal (PVA) including detection components that react with ceria.

According to an aspect of the present disclosure, a brush cleaning device includes a brush apparatus, a cleaning apparatus configured to clean the brush apparatus, and a sensing portion disposed in the cleaning apparatus and configured to sense a color change of the detection portion. The brush apparatus includes a main body portion, a plurality of protrusion portions, and a detection portion including detection components that react with ceria and is disposed in at least a part of the main body portion and the plurality of protrusion portions.

According to an aspect of the present disclosure, a brush cleaning method includes moving a brush apparatus to a close proximity of a cleaning apparatus, cleaning the brush apparatus using a cleaning portion of the cleaning apparatus, and sensing, with a sensing portion of the cleaning apparatus, a color change of a detection portion of the brush apparatus. The detection portion including detection components that react with ceria.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 shows a brush apparatus, according to an embodiment;

FIGS. 2 to 16 show brush apparatuses, according to various embodiments;

FIG. 17 illustrates a configuration of a brush cleaning device, according to an embodiment;

FIG. 18 depicts a brush cleaning device, according to an embodiment;

FIG. 19 shows a cleaning apparatus of a brush cleaning device, according to an embodiment;

FIG. 20 illustrates an example of a brush cleaning method, according to an embodiment; and

FIG. 21 depicts an example of a brush cleaning method, according to an embodiment.

### DETAILED DESCRIPTION

Hereinafter, with reference to the accompanying drawings, embodiments of the present disclosure are described such that a person of an ordinary skill may practice the disclosure in the technical field to which the present disclosure belongs. The present disclosure may be implemented in several different forms and is not limited to the embodiments described herein.

In order to explain the present disclosure in the drawings, parts without explanation and relationship may be omitted, and identical and/or similar components may be given the same reference number throughout the present disclosure.

In addition, the size and thickness of each component shown in the drawing may be arbitrarily indicated for better understanding and ease of description, and therefore the present disclosure is not necessarily limited to what is shown. In the drawings, the thickness of layers, films, panels, regions, and the like may be exaggerated for clarity. In addition, in the drawings, the thickness of some layers and regions may be exaggerated for better understanding and ease of description.

Throughout the present disclosure and the claims that follow, when an element is described as being “coupled” to another element, the element may be “directly connected” to the other element, but also may be “indirectly connected” to the other element between other members. In addition, unless explicitly described to the contrary, the word “comprise”, and variations such as “comprises” or “comprising”, are to be understood to imply the inclusion of stated elements but not the exclusion of any other elements.

It is to be understood that when an element, such as, but not limited to, a layer, film, region, or substrate, is referred to as being “on” another element, the element may be directly on the other element or intervening elements may also be present. Alternatively or additionally, when an element is referred to as being “directly on” another element, there may be no intervening elements present. Further, as used herein, the word “on” a target element is to be understood to be positioned above or below the target element, and may not be necessarily be understood to be positioned “at an upper side” based on an opposite to gravity direction.

Further, throughout the present disclosure, the phrase “on a plane” may refer to viewing a target portion from the top, and the phrase “on a cross-section” may refer to viewing a cross-section formed by vertically cutting a target portion from the side.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, and the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

As used herein, when an element or layer is referred to as “covering” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

As used herein, each of the terms “Bphen-Fe²⁺”, “Bphen-Fe³⁺”, “Ce⁴⁺”, “H₂O₂”, and the like may refer to a material made of elements included in each of the terms and is not a chemical formula representing a stoichiometric relationship.

Hereinafter, various embodiments of the present disclosure are described with reference to the accompanying drawings.

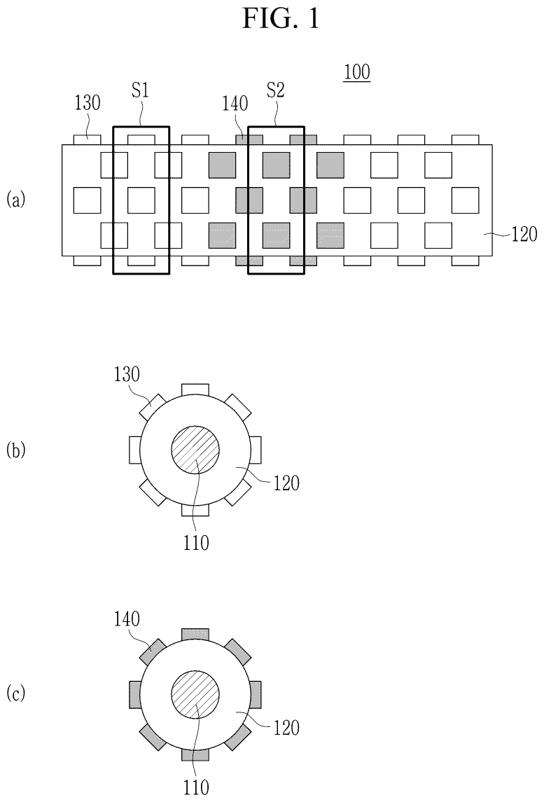

FIG. 1 shows a poly vinyl acetal (PVA) brush apparatus, according to an embodiment.

The brush apparatus 100, according to the present disclosure, may be and/or may include a PVA brush apparatus that may be used in a cleaning process after a chemical mechanical polishing (CMP) process, and may have a structure in which a plurality of protrusion portions 130 are protruded from a surface of a cylindrical brush apparatus for potentially increasing efficiency in removal of residuals in a substrate, when compared to related brush apparatuses.

The brush apparatus 100 may remove residues by contacting the plurality of protrusion portions 130 on the substrate through a rotation movement centered on a length direction, and a cleaning solution may be used together to potentially increase the cleaning efficiency of the substrate, when compared to related brush apparatuses.

The brush apparatus 100 may be manufactured through a process of mixing a resin mixture for cross-linking PVA with a pore forming agent to form pores, and then injection-molding the resin mixture to form the protrusion portion 130 protruded on the surface. After the injection-molding, pores may be formed in the brush apparatus 100 by removing the pore forming agent inside the brush apparatus 100 using a solution.

Since particles or an organic impurity generated during the manufacturing process may be present inside the brush apparatus 100, an internal impurity of the brush apparatus 100 may be transferred onto the substrate during a cleaning process of the substrate, thereby potentially causing deterioration of the production yield of the substrate. Accordingly, a preprocessing process (e.g., break-in process) to remove the internal impurity of the brush apparatus 100 may be necessary.

In the break-in process of the brush apparatus 100, de-ionized water (DIW) flow-through may be used to push the DIW through the pores of the brush apparatus 100 and through the core portion 110 disposed inside the brush apparatus 100 after mounting the brush apparatus 100 on the CMP equipment.

Apart from the break-in process of the brush apparatus 100 described above, cleaning of the brush apparatus 100 may also be necessary after cleaning the substrate. That is, the brush apparatus 100 may become contaminated from the substrate during the process of cleaning the substrate, and as such, may contaminate a subsequent substrate during the cleaning of the subsequent substrate.

The brush apparatus 100, according to the present disclosure, may be provided to detect contamination of the brush apparatus 100 contaminated by ceria during the process of cleaning the substrate.

That is, the detection portion 140 may detect ceria that is placed in a part of the main body portion 120 and the protrusion portion 130 of the brush apparatus 100. The detection portion 140 may include PVA, and the PVA that forms the detection portion 140 may contain a detection component that reacts with ceria.

Hereinafter, the brush apparatus 100, a brush cleaning device, and a brush cleaning method using the same, according to various embodiments of the present disclosure, are described with reference to the drawings.

Referring to FIG. 1, (a) shows one side surface of the brush apparatus 100, (b) shows a cross-sectional view of region S1 in (a), and (c) is a cross-sectional view of region S2 in (a).

As shown in (a), (b), and (c) of FIG. 1, the brush apparatus 100, according to the present disclosure, is a PVA brush apparatus, and may include a core portion 110 that rotates around a length direction as an axis, a main body portion 120 surrounding the core portion 110, a plurality of protrusion portions 130 protruded from the main body portion 120, and a detection portion 140 placed in at least a part of the main body portion 120 and the plurality of protrusion portions 130.

In an embodiment, the detection portion 140 may be formed of PVA with a detection component that may react with ceria. For example, the detection component may include at least one of a Bphen-Fe²⁺ component and a dye. That is, the Bphen-Fe²⁺ component and the dye may be included in the brush apparatus 100 and may react with ceria to cause a color change of the brush apparatus 100.

The Bphen-Fe²⁺ component and the dye may have a color (e.g., red), but due to reaction with the ceria component, the color may become lighter and/or may gradually turn white. The dye included in the detection component may be a dye that may be decomposed by an oxygen-hydrogen (OH) radical.

The detection components (e.g., the Bphen-Fe²⁺ component and the dye) may be small components and may not have an effect between the brush apparatus 100 and the substrate.

The detection portion 140 of the brush apparatus 100, according to the present disclosure, may be disposed in at least a part of the main body portion 120 and the plurality of protrusion portions 130. Alternatively or additionally, the detection portion 140 may be disposed in the entire main body portion 120 and the plurality of protrusion portions 130. As another example, the detection portion 140 may be disposed in the main body portion 120 or the plurality of protrusion portions 130.

Referring to (a) of FIG. 1, the brush apparatus 100 may include a cylindrical-shaped main body portion 120 and the plurality of protrusion portions 130 may form to protrude from the surface of the main body portion 120, and the detection portion 140 may be disposed in a part of the plurality of protrusion portions 130.

Referring to (b) of FIG. 1, the detection portion 140 may not be disposed in region S1, and the core portion 110, the main body portion 120, and the protrusion portion 130 disposed in region S1 may have the same shape as those provided in a related brush apparatus.

Referring to (c) of FIG. 1, the detection portion 140 may be disposed in the protrusion portion 130 and the detection portion 140 may not be disposed in the main body portion 120 at region S2 of (a).

That is, in the brush apparatus 100 shown in (a), the detection portion 140 may be disposed only in some of the plurality of protrusion portions 130. In particular, (a) of FIG. 1 may correspond to an embodiment of the brush apparatus 100 in which the detection portion 140 may be disposed in a protrusion portion 130 positioned in a middle of one end and the other end when the start and the end of the main body portion 120 in the length direction are respectively set to one end and the other end.

In addition, as shown in (c) of FIG. 1, the detection portion 140 disposed in each protrusion portion 130 may include the same content of detection components throughout the detection portion 140, regardless of a distance from the main body portion 120. That is, in (c) of FIG. 1, the entire detection portion 140 is shown in the same shade, which may indicate that the entire detection portion 140 has the same content of detection components.

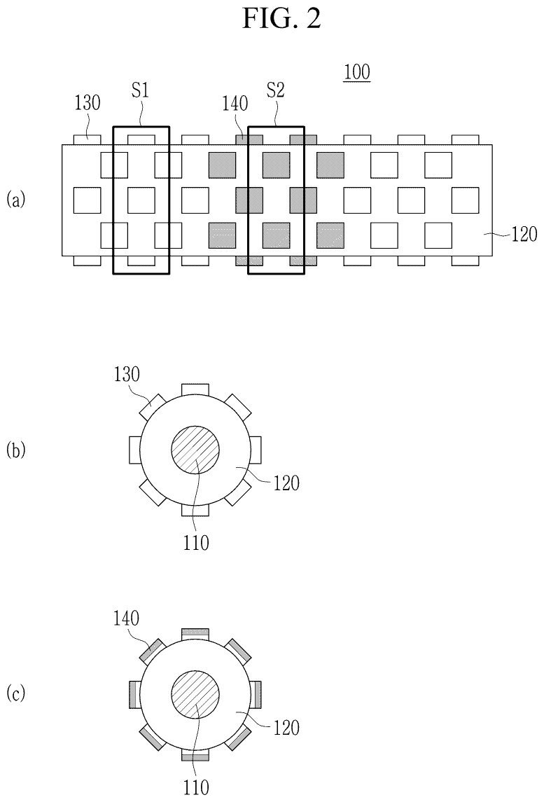

In (a) of FIG. 1, an embodiment in which the detection portion 140 is disposed only in some of the plurality of protrusion portions 130 is illustrated. FIGS. 2 to 16 illustrate various embodiments of the brush apparatus 100 according to positions of the detection portion 140 disposed in different positions.

In FIG. 2, (a) shows one side surface of the brush apparatus 100, (b) shows a cross-section view of (a), taken along region S1, and (c) shows a cross-section view of (a), taken along region S2.

As shown in FIG. 1, in the brush apparatus 100 shown in (a), (b), and (c) of FIG. 2, the detection portion may not be disposed in region S1, and the core portion 110, the main body portion 120, and the protrusion portion 130 positioned in region S2 may have a substantially similar and/or the same shape as a related brush apparatus, and the detection portion 140 may not be disposed in the main body portion 120.

However, the detection portion 140 of (c) in FIG. 2 may be different from the detection portion 140 show in (c) of FIG. 1 in that the content of the detected component may vary depending on a distance from the main body portion 120.

Unlike the detection portion 140 shown in the same shade in (c) of FIG. 1, the detection portion 140 shown in (c) of FIG. 2 is shown with darker shade as the detection portion 140 moves away from the main body portion 120. That is, the farther away from the main body portion 120, the higher the detection component content of the detection portion 140.

That is, the brush apparatus 100 in the cross-section view of region S2 shown in (c) of FIG. 2 corresponds to an embodiment in which a lower portion of the detection portion 140, which is in contact with the main body portion 120, contains no or almost no detection components, and the content of the detection components increases as it moves toward an upper end of the detection portion 140. Alternatively or additionally, the detection component may be included only at the upper end of the detection portion 140.

As shown in (c) of FIG. 1 and (c) of FIG. 2, in the brush apparatus 100, according to the present disclosure, the detection portion 140 may be disposed in a part of the plurality of protrusion portions 130. In such an embodiment, each detection portion 140 may include a detection component with the same content throughout the detection portion 140, regardless of the distance from the main body portion 120, or may include detection components with different content depending on a distance from the main body portion 120.

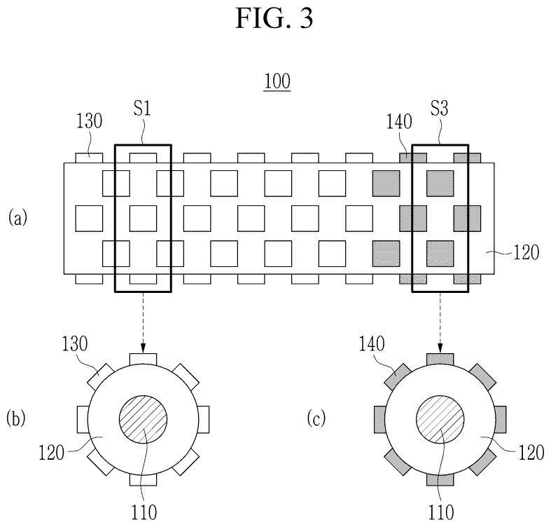

In FIG. 3, (a) shows one side surface of the brush apparatus 100, (b) shows a cross-section view of (a), taken along region S1, and (c) shows a cross-section view of (a), taken along region S2.

Referring to (a), (b), and (c) in FIG. 3, the detection portion 140 may be disposed on some of the plurality of protrusion portions 130 formed to protrude on a surface of the main body portion 120. The detection portion 140 may not be disposed in region S1 and may be disposed only in the protrusion portion 130 in region S3, and the detection portion 140 may not be disposed in the main body portion 120.

When the start and the end of the main body portion 120 in the length direction are set as one end and the other end, unlike (a) of FIG. 1 in which the detection portion 140 is disposed in a middle position of one end and the other end, the brush apparatus 100 shown in (a) of FIG. 3 corresponds to an embodiment in which the detection portion 140 is disposed only in the protrusion portion 130 disposed at one end of the main body portion 120.

In an embodiment, in the detection portion 140 of (c) of FIG. 3, the entire detection portions 140 include the same content of detection components, regardless of the distance from the main body portion 120.

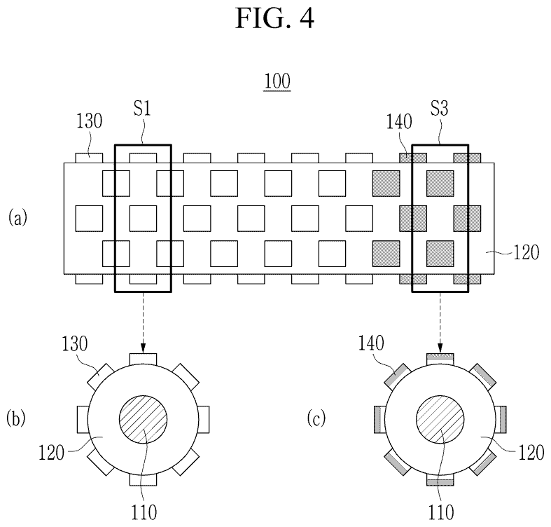

In FIG. 4, (a) shows one side surface of the brush apparatus 100, (b) shows a cross-section view of (a), taken along region S1, and (c) shows a cross-section view of (a), taken along region S3.

As shown in FIG. 3, in the brush apparatus 100 shown in FIG. 4, the detection portion 140 is disposed only in the protrusion portion 130 and not disposed in the main body portion 120 in region S3.

However, unlike the detection portion 140 shown in (c) of FIG. 3, the detection portion 140 shown in (c) of FIG. 4 depicts an embodiment in which the content of the detection component varies depending on the distance from the main body portion 120.

That is, as shown in (c) of FIG. 4, the detection portion 140 disposed in the protrusion portion 130 disposed at one end of the main body portion 120 may contain a higher detection component content as the detection portion 140 moves away from the main body portion 120.

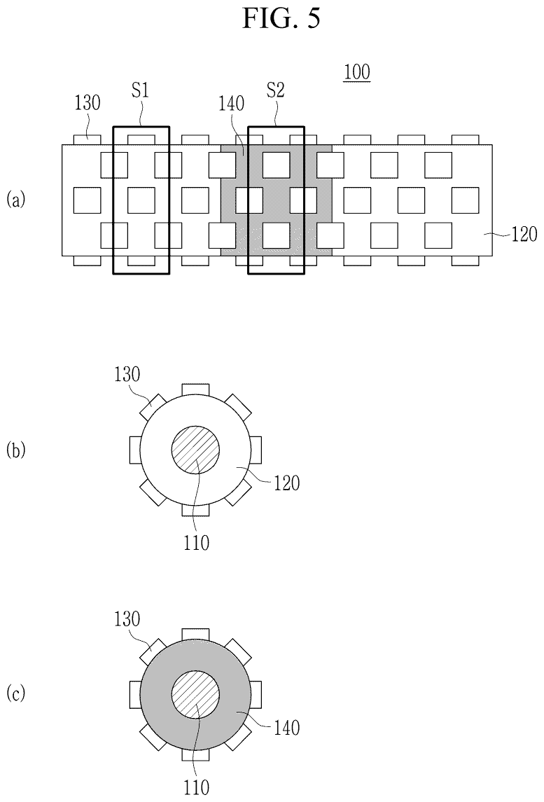

In FIG. 5, (a) shows one side surface of the brush apparatus 100, (b) shows a cross-section view of (a), taken along region S1, and (c) shows a cross-section view of (a), taken along region S2.

Referring to FIG. 5, the detection portion 140 may be disposed in a part of the main body portion 120 of the brush apparatus 100. When the start and the end of the main body portion 120 in the length direction are set as one end and the other end, the detection portion 140 may be disposed in the main body portion 120 disposed in region S2 placed at a middle of the one end and the other end. The detection portion 140 may not be disposed in the main body portion 120 at the position region S1.

As shown in (c) of FIG. 5, the detection portion 140 disposed in the main body portion 120 may include detection components of the same content in an inner portion close to the inner side where the main body portion 120 is in contact with the core portion 110 and an outer portion close to the exterior side where the main body portion 120 is in contact with the plurality of protrusion portion 130. In (c) of FIG. 5, the entire detection portion 140 is shown in the same shade, which may indicate that the entire detection portion 140 has the same content of detection components.

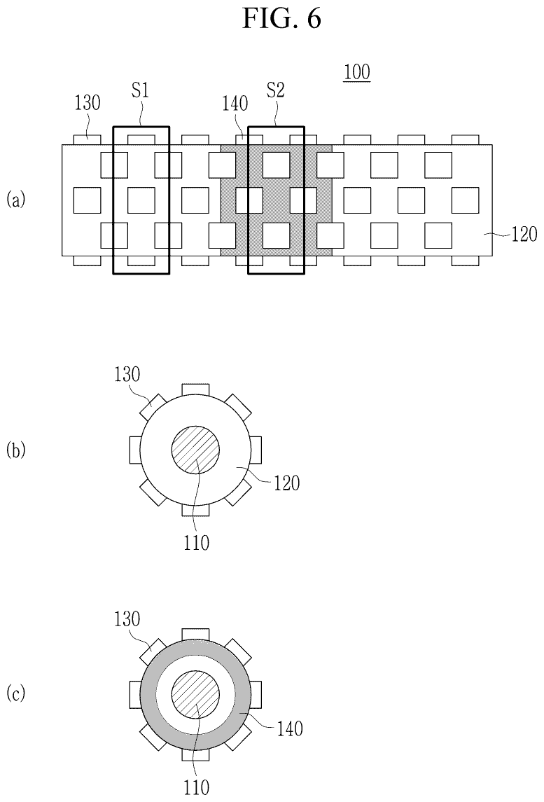

Referring to FIG. 6, (a) shows one side surface of the brush apparatus 100, (b) shows a cross-section view of (a), taken along region S1, and (c) shows a cross-section view of (a), taken along region S2.

As shown in FIG. 5, in the brush apparatus 100 shown in FIG. 6, the detection portion 140 may be disposed only in the main body portion 120 positioned in region S2 and the detection portion 140 may not be disposed in the protrusion portion 130.

However, unlike the detection portion 140 shown in (c) of FIG. 5, the detection portion 140 shown in (c) of FIG. 6 may correspond to an embodiment in which a different content of detection component may be included in the main body portion 120.

In the detection portion 140 in (c) of FIG. 6, the detection portion 140 may include detection components of different contents in an inner portion close to the inner side where the main body portion 120 may be in contact with the core portion 110 and an outer portion in close proximity to the exterior side where the main body portion 120 is in contact with the plurality of protrusion portion 130. That is, the closer to the outer portion of the main body portion 120, the higher the content of detection components that may be included in the detection portion 140.

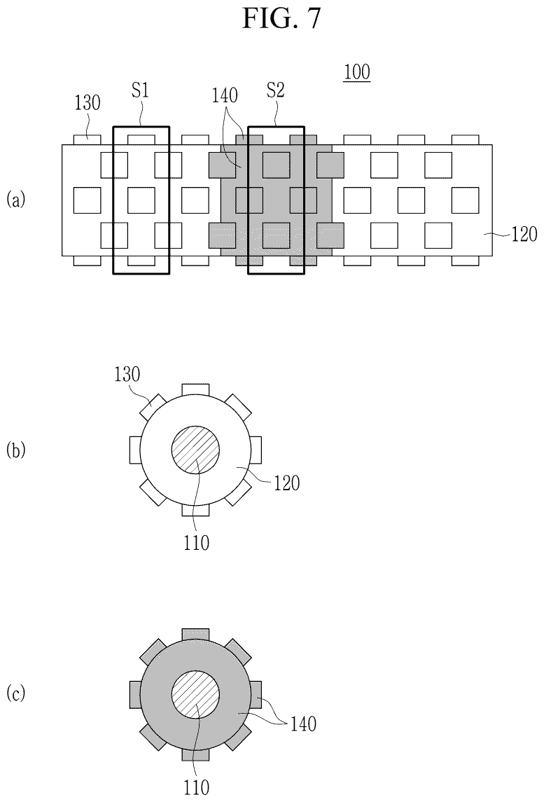

Referring to FIG. 7, (a) shows one side surface of the brush apparatus 100, (b) shows a cross-section view of (a), taken along region S1, and (c) shows a cross-section view of (a), taken along region S2.

Referring to FIG. 7, the detection portion 140 may be disposed in a part of the main body portion 120 of the brush apparatus 100. For example, when the start and the end of the main body portion 120 in the length direction are set at one end and the other end, the detection portion 140 may be disposed in both of the main body portion 120 and the protrusion portion 130 disposed in region S2 may be placed at a middle of the one end and the other end, and as shown in (b) of FIG. 7, the detection portion 140 may not be disposed in the main body portion 120 and the protrusion portion 130 disposed in region S1.

As shown in (c) of FIG. 7, the detection portion 140 disposed in the main body portion 120 and the protrusion portion 130 may include detection components of the same content.

That is, (c) of FIG. 7 corresponds to an embodiment in which the detection portion 140 disposed in the main body portion 120 may include detection components of the same content in an inner portion close to the inner side where the main body portion 120 is in contact with the core portion 110 and an outer portion close to the exterior side where the main body portion 120 is in contact with the plurality of protrusion portion 130, and the protrusion portions 130 formed on the surface of the main body portion 120 where the detection portion 140 is disposed also include a detection component of the same content.

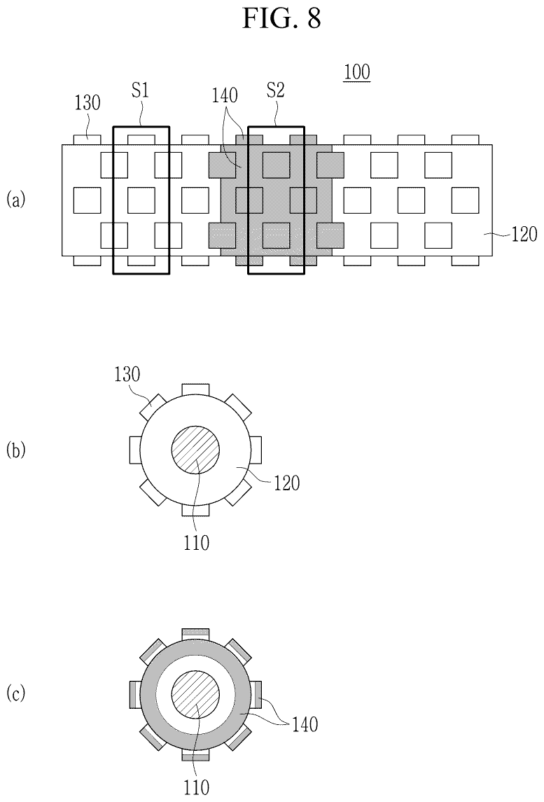

In FIG. 8, (a) shows one side surface of the brush apparatus 100, (b) shows a cross-section view of (a), taken along region S1, and (c) shows a cross-section view of (a), taken along region S2.

Referring to FIG. 8, as shown in (c) of FIG. 7, when the start and the end of the main body portion 120 in the length direction are set as one end and the other end, the detection portion 140 may be disposed in the main body portion 120 and the protrusion portion 130 disposed at a middle position region S2 of the one end and the other end.

However, (c) of FIG. 8 shows a case where the content of the detection components included in the detection portions 140 disposed in the main body portion 120 and the protrusion portion 130 may be different.

In (c) of FIG. 8, the detection portion 140 is shown with darker shade as the detection portion 140 moves away from the main body portion 120, which may indicate that the farther away from the main body portion 120, the higher the detection component content of the detection portion 140 may be. That is, in the brush apparatus 100 at region S2 shown in (c) of FIG. 8, a lower end of the detection portion 140, which is in contact with the main body portion 120, may contain almost no detection components, and the content of the detection components may increase toward an upper end of the detection portion 140.

In addition, a case where the detection portion 140 disposed in the main body portion 120 includes detection components of the different contents in an inner portion close to the inner side where the main body portion 120 is in contact with the core portion 110 and an outer portion close to the exterior side where the main body portion 120 is in contact with the plurality of protrusion portion 130, and the closer to the outer portion of the main body portion 120, the higher the content of detection components included in the detection portion 140.

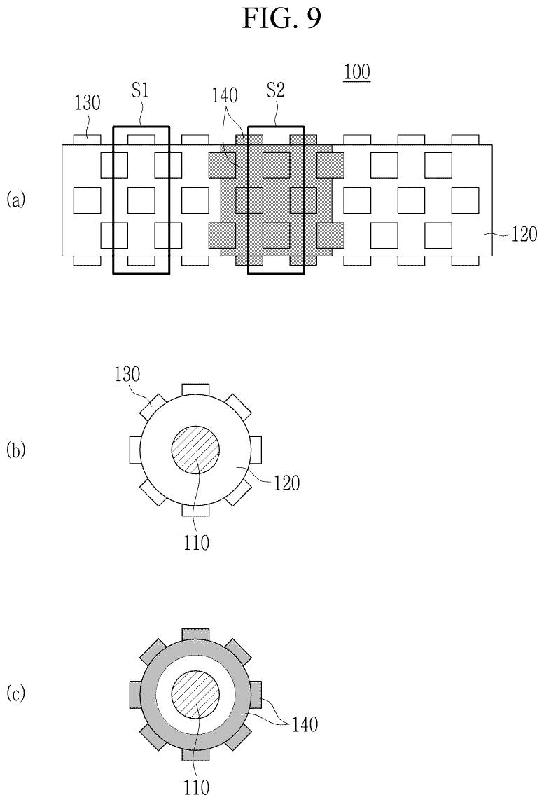

In FIG. 9, (a) shows one side surface of the brush apparatus 100, (b) shows a cross-section view of (a), taken along region S1, and (c) shows a cross-section view of (a), taken along region S2.

Referring to (c) of FIG. 9, a case where the detection portion 140 disposed in the main body portion 120 includes the detection component with a content increasing as the detection portion 140 approaches the outer portion of the main body portion 120 is illustrated. In addition, the detection portion 140 disposed in the protrusion portion 130 includes the same content of detection components throughout the detection portion 140, regardless of the distance from the main body portion 120.

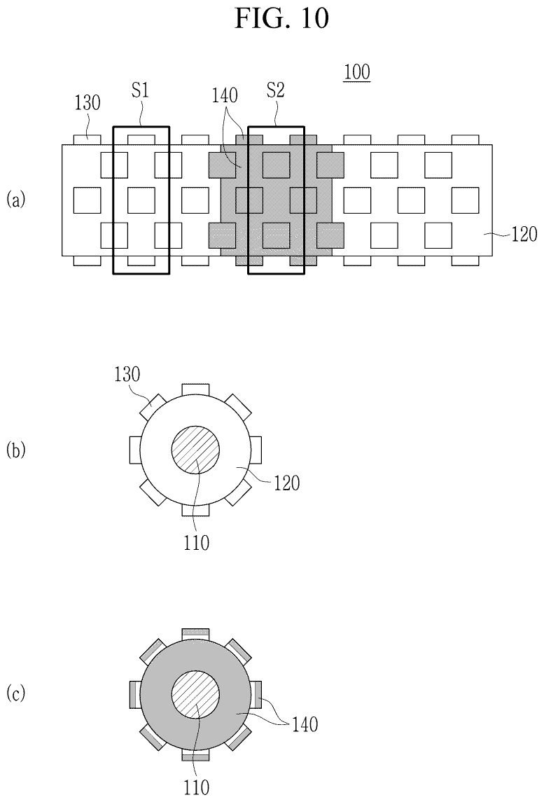

In FIG. 10, (a) shows one side surface of the brush apparatus 100, (b) shows a cross-section view of (a), taken along region S1, and (c) shows a cross-section view of (a), taken along region S2.

Referring to (c) of FIG. 10, the detection portion 140 disposed in the main body portion 120 may include detection components of the same content in an inner portion close to the inner side where the main body portion 120 is in contact with the core portion 110 and an outer portion close to the exterior side where the main body portion 120 is in contact with the plurality of protrusion portion 130, and the detection portion 140 disposed in the protrusion portion 130 contains a higher detection component content as it moves away from the main body portion 120.

In the brush apparatus 100, according to the present disclosure, at least one or more detection portions 140 may be disposed in at least two or more sections divided along the length direction of the main body portion 120.

In addition, when the detection portion 140 disposed in each section as described above is provided in plurality, the positions where the detection portions 140 are disposed may be different from each other or may be the same.

For example, assuming that there are three (3) sections, the detection portion 140 may be placed in the protrusion portion 130 in one section, and the detection portion 140 may not be placed in the remaining two (2) sections. Alternatively, the detection portion 140 may be placed in the main body portion 120 in one section, and the detection portion 140 may be placed in the protrusion portion 130 in the other two (2) sections.

According to another embodiment, the content of detection components included in each detection portion 140 may be different. For example, assuming that there are three (3) sections, the detection portion 140 may be placed in the main body portion 120 in two (2) sections, and the detection portion 140 may not be placed in the remaining section. In such an embodiment, the content of the detection component included in each detection portion 140 disposed in the two (2) sections may be different.

In each of FIGS. 1 to 10, when the main body portion 120 is divided into regions S1, S2, and S3 and one end and the other end are set in the length direction of the main body portion 120, one end, the other end, and the middle portion position between one end and the other end have been described.

Although FIGS. 1 to 10 are described by dividing the main body portion 120 into three (3) sections, the present disclosure is not limited in this regard, and the number of sections is not limited to three (3). That is, the main body portion 120 may be divided into a plurality of sections, and the detection portion 140 may be included in at least one or more sections among the plurality of sections.

When the detection portion 140 is disposed in a plurality of sections, the detection portions 140 disposed in the respective sections may have the same arrangement structure and may include detection components of the same content, and each detection portion 140 may include detection components of a different content.

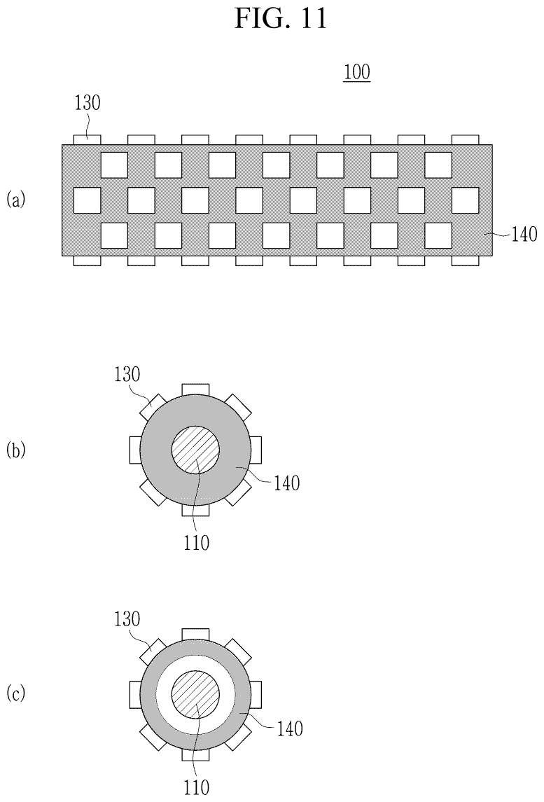

Unlike the brush apparatus 100 shown in FIGS. 1 to 10, a brush apparatus 100 shown in FIGS. 11 to 16 corresponds to a case where the brush apparatus 100 is not divided into plurality of sections along a length direction of the main body portion 120, and a detection portion 140 is disposed in the entire section. That is, FIGS. 1 10 correspond to embodiments in which the arrangement form of the detection portions 140 is not different for each section of regions S1, S2, and S3, and the detection portion 140 is disposed in the same form in each cross-section.

In FIG. 11, (a) shows one side surface of the brush apparatus 100, (b) and (c) each shows one cross-section in any position and respectively show different embodiments.

As shown in (a) of FIG. 11, the detection portion 140 is disposed throughout the main body portion 120, and the detection portion 140 may not be disposed in the protrusion portion 130. In (b) and (c) of FIG. 11 respectively show cases in which the shapes of the detection portions 140 disposed in the main body portion 120 are different.

FIG. 11 (b) shows an embodiment in which the detection portion 140 disposed along the entire length direction of the main body portion 120 includes detection components of the same content in an inner portion close to the inner side where the main body portion 120 is in contact with the core portion 110 and an outer portion close to the exterior side where the main body portion 120 is in contact with the plurality of protrusion portion 130, and the closer to the outer portion of the main body portion 120.

FIG. 11 (c) shows an embodiment in which the detection portion 140 disposed along the entire length direction of the main body portion 120 includes the content of the detection component increasing as it approaches the outer portion of the main body portion 120.

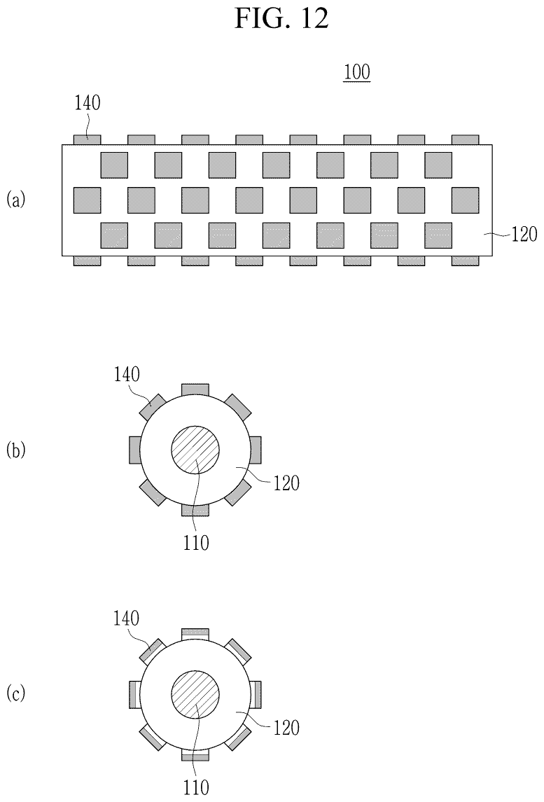

In FIG. 12, (a) shows one side surface of the brush apparatus 100, (b) and (c) each shows a random cross-section view in (a), and (b) and (c) respectively illustrate different embodiments.

In (a) of FIG. 12, the detection portion 140 is disposed in the entire plurality of protrusion portions 130 and not disposed in the main body portion 120, and (b) and (c) of FIG. 11 respectively illustrate different embodiments of the detection portion 140 disposed in the protrusion portion 130.

For example, (b) of FIG. 12 shows an embodiment in which the detection portion 140 disposed in the protrusion portion 130 includes the same content of the detection components regardless of a distance from the main body portion 120.

As another example, (c) of FIG. 12 shows an embodiment in which the detection portion 140 disposed in the protrusion portion 130 includes a different content of the detection component depending on a distance from the main body portion 120, and the detection portion 140 contains a higher detection component content as it moves away from the main body portion 120.

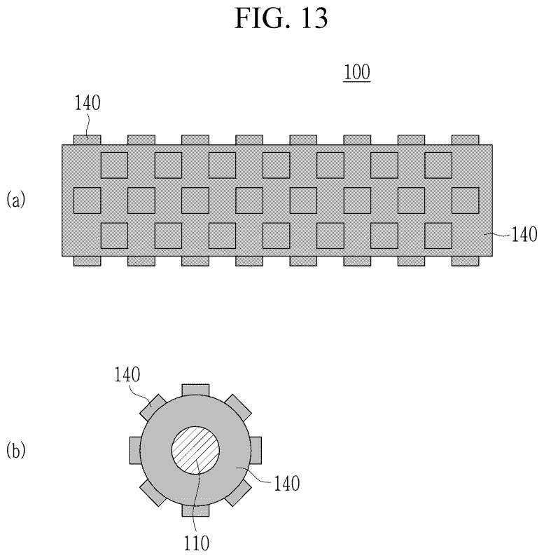

FIGS. 13 to 16 show an embodiment of the brush apparatus 100 in which the detection portion 140 is entirely disposed in the main body portion 120 and the protrusion portion 130.

FIG. 13 (a) to FIG. 16 (a) show one side surface of the brush apparatus 100, and they are shown substantially similar and/or identical in appearance.

FIG. 13 (b) to FIG. 16 (b) show a cross-section in the brush apparatus 100 shown in each of FIG. 13 (a) to FIG. 16 (a), and the content of the detection component included in the detection portion 140 may be different.

For example, (b) of FIG. 13 shows an embodiment in which the detection portion 140 disposed in the main body portion 120 and the protrusion portion 130 both contain the same content of detection components.

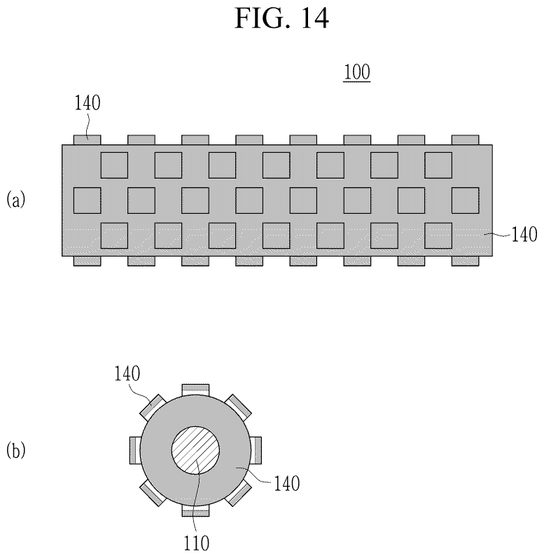

In the case of the brush apparatus 100 shown in (b) of FIG. 14, the detection portion 140 disposed in the main body portion 120 may contain the same content of detection components, and the detection portion 140 disposed in the protrusion portion 130 may contain a higher content of the detection component as the detection portion 140 moves away from the main body portion 120.

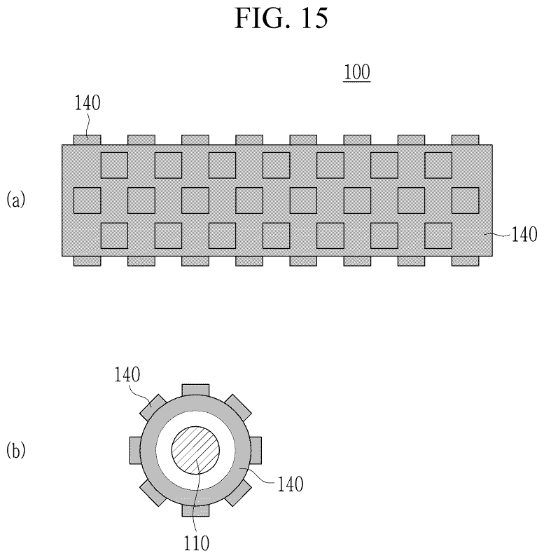

In the case of (b) of FIG. 15, the content of the detection component of the detection portion 140 disposed in the main body portion 120 may increase as it is closer to the outer portion of the main body portion 120. That is, (b) of FIG. 15 depicts an embodiment in which the detection portion 140 disposed in the protrusion portion 130 includes the same content of detection components in the entire detection portion 140, regardless of a distance from the main body portion 120.

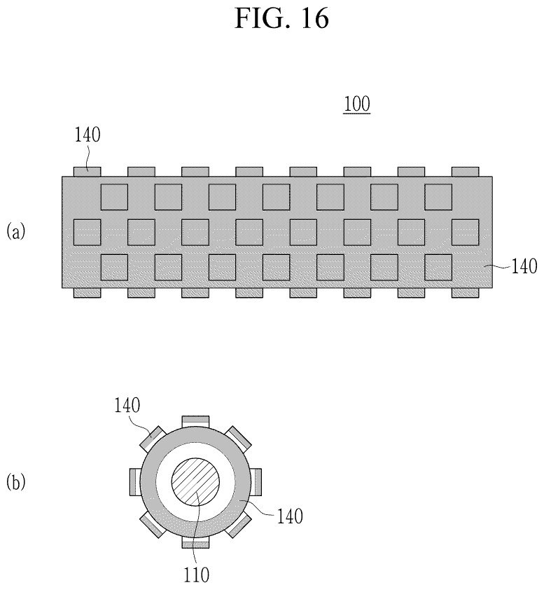

In the case of the brush apparatus 100 shown in (b) of FIG. 16, the detection portion 140 disposed in the protrusion portion 130 includes a content of the detection component increasing as closer to the upper end of the detection portion 140, and the detection portion 140 disposed in the main body portion 120 includes a content of the detection component increasing as closer to the outer portion of the main body portion 120.

The brush apparatus 100, according to the present disclosure, may include the detection portion 140 disposed at various positions as described with reference to FIGS. 1 to 16.

Accordingly, according to the contamination pattern of the substrate, the contamination level of the substrate may be determined more efficiently by selecting and using the brush apparatus 100 in consideration of the placement position of the detection portion 140.

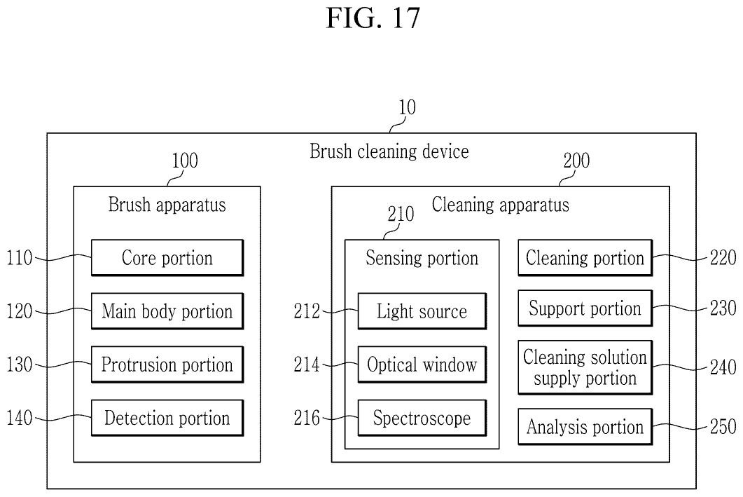

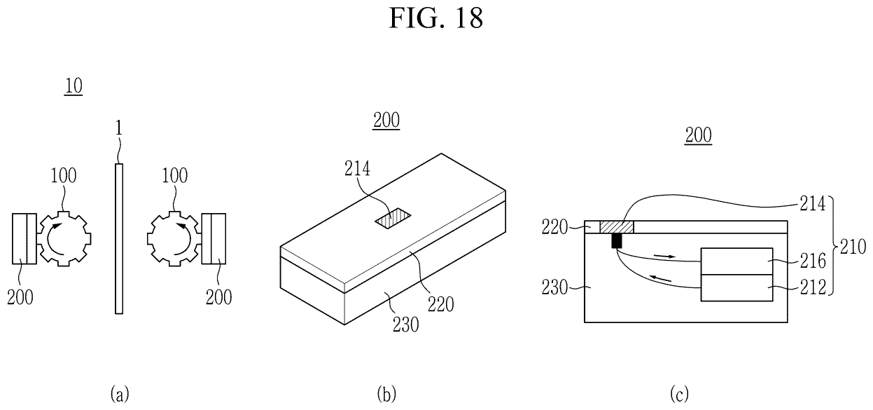

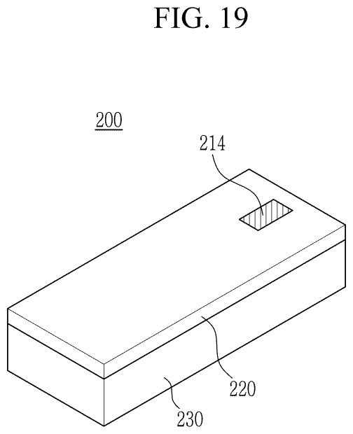

FIG. 17 illustrates a configuration of a brush cleaning device, according to an embodiment. FIG. 18 depicts the brush cleaning device, according to an embodiment. FIG. 19 shows a cleaning apparatus of a brush cleaning device, according to an embodiment.

As shown in FIGS. 17 and 18, a brush cleaning device 10, according to the present disclosure, may include a brush apparatus 100 in which a detection portion 140 including a detection component that reacts with ceria is disposed in at least a part of a main body portion 120 and a plurality of protrusion portions 130, a cleaning apparatus 200 that washes the brush apparatus 100, and a sensor 210 that senses color change of the detection portion 140.

The brush apparatus 100 may be and/or may include a PVA brush apparatus, and may include a core portion 110 that rotates around a length direction as an axis, a main body portion 120 that surrounds the core portion 110, a plurality of protrusion portions 130 protruded from the main body portion 120, and a detection portion 140 disposed in at least a part of the main body portion 120 and the plurality of protrusion portion 130.

The cleaning apparatus 200 may include a cleaning portion 220 of which one surface is in contact with the brush apparatus 100 to clean the brush apparatus 100, a support portion 230 connected to the other side of the cleaning portion 220 and supporting the cleaning portion 220, and a cleaning solution supply portion 240 that supplies a cleaning solution toward the brush apparatus 100. A cleaning solution containing H₂O₂ may be used to clean the brush apparatus 100. However, the present disclosure is not limited in this regard, and the cleaning solution may contain other chemical compounds.

The sensing portion 210 may include a light source 212 that irradiates beams, an optical window 214 that is disposed on one side of the cleaning portion 220 to face the brush apparatus 100 and causes the beam to enter the brush apparatus 100, and a spectroscope 216 that receives the beam reflected from the brush apparatus 100 and re-incident to the optical window 214 and measures the spectrum of the beam.

When the brush apparatus 100 is contaminated with ceria, the color of the detection portion 140 changes from having a color (e.g., red) to white, and the sensor 210 may detect such a color change to predict the degree of contamination of the brush apparatus 100.

FIG. 18 (a) shows a brush apparatus 100 disposed at lateral side of the substrate 1 and a cleaning apparatus 200 disposed at a side surface of each brush apparatus 100.

After the cleaning of the substrate 1 is completed, the brush apparatus 100 may be cleaned by the cleaning portion 220 of the cleaning apparatus 200, and during the cleaning process, the brush apparatus 100 may rotate around its axis.

FIG. 18 (b) is an enlarged view of the cleaning apparatus 200, and as shown in FIG. 18 (a), the cleaning apparatus 200 may include a cleaning portion 220 of which one side contacts the brush apparatus 100 to clean the brush apparatus 100, a support portion 230 disposed to contact the other side of the cleaning portion 220 and supporting the cleaning portion 220. The optical window 214 is disposed in the cleaning portion 220, and thus the optical window 214 may face the brush apparatus 100 while cleaning the brush apparatus 100.

As shown in FIG. 18 (c), the sensing portion 210 may be disposed in the cleaning apparatus 200.

In the support portion 230, a light source 212 that irradiates a beam and a spectroscope 216 that receives the beam reflected from the brush apparatus 100 and re-incident to the optical window 214 and measures the spectrum of the beam may be disposed.

The optical window 214 may be disposed in the cleaning portion 220 to face the brush apparatus 100 and incident the beam toward the brush apparatus 100.

FIG. 19 shows another embodiment of the cleaning apparatus 200 shown in FIG. 18 (b). In FIG. 18 (b), the optical window 214 is disposed at a center of the cleaning portion 220, but in FIG. 19, the optical window 214 is disposed at a peripheral portion of the cleaning portion 220.

However, the position of the optical window 214 disposed in the cleaning portion 220 is not limited to any one point. That is, the optical window 214 may be disposed at any position on the cleaning portion 220.

In order to sense the color change of the detection portion 140 of the brush apparatus 100 through the optical window 214, the position of the optical window 214 disposed on the cleaning portion 220 may be arranged to correspond to the detection portion 140 of the brush apparatus 100.

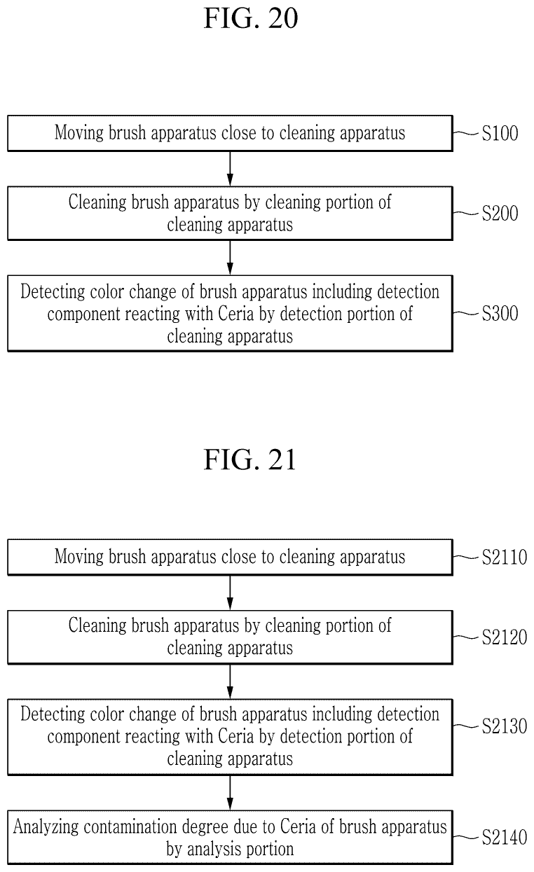

FIG. 20 illustrates an example of a brush cleaning method, according to an embodiment.

As shown in FIG. 20, a brush cleaning method of a brush cleaning device 10, according to the present disclosure, may include moving the brush apparatus 100 in close proximity (e.g., near) to the cleaning apparatus 200 (operation S100), cleaning the brush apparatus 100 by the cleaning portion 220 of the cleaning apparatus 200 (operation S200), and sensing the color change of the brush apparatus 100 containing a detection component that reacts with ceria by the sensing portion 210 of the cleaning apparatus 200 (operation S300).

The cleaning of the brush apparatus 100 (operation S200) may include rotating the brush apparatus 100 around the core portion 110 disposed at a center and supplying a cleaning solution toward the brush apparatus 100 by the cleaning solution supply portion 240.

The detecting of the color change (operation S300) may include irradiating a beam to the brush apparatus 100 through the optical window 214 disposed on one side of the cleaning portion 220 by the light source 212 disposed in the cleaning apparatus 200, re-entering of the beam that heads toward the brush apparatus 100 after passing through the optical window 214 and then reflected from the brush apparatus 100 to the optical window 214, and measuring a spectrum of the beam re-incident on the optical window 214.

In an embodiment, the contamination of the brush apparatus 100 may be measured by measuring the change in intensity of the beam that passes through the optical window 214 and is transmitted to the brush apparatus 100, and is then re-reflected and re-entered through the optical window 214.

The detection portion 140 may include a color detection component, but when contaminated with ceria, the detection portion 140 changes to white, and the change in beam intensity according to the color change of the detection portion 140 may be measured.

For example, when the detection portion 140 has a color (e.g., red), the beam intensity may remain high, however, when the detection portion 140 changes to the white, the beam intensity may decrease such that the degree of contamination may be quantitatively measured through the above-stated change in intensity.

FIG. 21 illustrates an example of a brush cleaning method, according to an embodiment.

As shown in FIG. 21, a brush cleaning method of the brush cleaning device 10, according to the present disclosure, may include moving close to the cleaning apparatus 200 (operation S2110), cleaning the brush apparatus 100 by the cleaning portion 220 of the cleaning apparatus 200 (operation S2120), and sensing a color change of the detection portion 140 of the brush apparatus 100 containing a detection component that reacts ceria by the sensing portion 210 of the cleaning apparatus 200 (operation S2130), and accordingly, analyzing the degree of contamination due to ceria in the brush apparatus 100 according to a result measured by the analysis portion 250 in the spectroscope 216 (operation S2140) may further be included.

In the color change of the detection portion 140, when the detection portion 140 contains a Bphen-Fe²⁺ component, the red Bphen-Fe²⁺ component included in the detection portion 140 may be changed to a white Bphen-Fe³⁺ component due to the Ce⁴⁺ of ceria being absorbed to the brush apparatus 100 such that the color of the detection component may change.

When the detection portion 140 contains a dye, the color change of the detection portion 140 may be carried out during a process of cleaning the brush apparatus 100 by the brush cleaning device 10.

In an embodiment, in order to clean the brush apparatus 100, a cleaning solution may be sprayed to the brush apparatus 100 through an operation in which the brush apparatus 100 moves close to the cleaning apparatus 200 and rotates around the core portion 110 disposed at a center, and an operation in which the cleaning solution supply portion 240 supplies the cleaning solution toward the brush apparatus 100). In such an embodiment, generating an OH radical as Ce³⁺ attached to the brush apparatus 100 reaches with H₂O₂ contained in the cleaning solution and changes to Ce⁴⁺ and decomposing the dye by the OH radical and color-changing the detection portion 140 to white may be included.

While present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

What is claimed is:

1. A brush apparatus, comprising:
a core portion rotating around a length direction as an axis;
a main body portion at least partially surrounding the core portion;
a plurality of protrusion portions protruding from the main body portion; and
a detection portion disposed in at least one of a part of the main body portion or the plurality of protrusion portions,
wherein the detection portion is formed of poly vinyl acetal (PVA) comprising detection components that react with ceria.

2. The brush apparatus of claim 1, wherein the detection components comprise at least one of a Bphen-Fe²⁺ component and a dye.

3. The brush apparatus of claim 1, wherein the plurality of protrusion portions have a same shape.

4. The brush apparatus of claim 2, wherein the dye comprises a dye that is decomposed by OH radicals.

5. The brush apparatus of claim 1, wherein a first content of the detection components in an inner portion of the detection portion in close proximity to an inner side where the main body portion is in contact with the core portion is same as a second content of the detection components in an outer portion of the detection portion in close proximity to an outer side where the main body portion is in contact with the plurality of protrusion portions.

6. The brush apparatus of claim 1, wherein a first content of the detection components in an inner portion of the detection portion in close proximity to an inner side where the main body portion is in contact with the core portion differs from a second content of the detection components in an outer portion of the detection portion in close proximity to an outer side where the main body portion is in contact with the plurality of protrusion portions.

7. The brush apparatus of claim 6, wherein the second content of the detection components in the outer portion of the detection portion is greater than the first content of the detection components in the inner portion of the detection portion.

8. The brush apparatus of claim 1, wherein a content of the detection components in a portion of the detection portion disposed in the plurality of protrusion portions varies based on a distance from the main body portion.

9. The brush apparatus of claim 1, wherein a content of the detection components in a portion of the detection portion disposed in the plurality of protrusion portions is same throughout the portion of the detection portion regardless of a distance from the main body portion.

10. A brush cleaning device, comprising:
a brush apparatus comprising:
a main body portion;
a plurality of protrusion portions; and
a detection portion comprising detection components that react with ceria and is disposed in at least a part of the main body portion and the plurality of protrusion portions;
a cleaning apparatus configured to clean the brush apparatus; and
a sensing portion disposed in the cleaning apparatus and configured to sense a color change of the detection portion.

11. The brush cleaning device of claim 10, wherein the cleaning apparatus comprises:
a cleaning portion having one side that contacts the brush apparatus and cleans the brush apparatus;
a support portion coupled with the other side of the cleaning portion and supports the cleaning portion; and
a cleaning solution supply portion configured to supply a cleaning solution to the brush apparatus.

12. The brush cleaning device of claim 10, wherein the detection portion comprises:
a light source configured to irradiate a beam;
an optical window disposed on a side of a cleaning portion to face the brush apparatus and configured to direct the beam incident on the brush apparatus; and
a spectroscope configured to receive the beam reflected from the brush apparatus and re-incident into the optical window and to measure a spectrum of the beam.

13. The brush cleaning device of claim 10, wherein the detection portion is formed of a poly vinyl acetal (PVA) comprising the detection components that react with the ceria.

14. The brush cleaning device of claim 10, wherein a part of the detection portion disposed in the plurality of protrusion portions comprises different contents of the detection components that vary based on a distance from the main body portion.

15. A brush cleaning method, comprising:
moving a brush apparatus to a close proximity of a cleaning apparatus;
cleaning the brush apparatus using a cleaning portion of the cleaning apparatus; and
sensing, with a sensing portion of the cleaning apparatus, a color change of a detection portion of the brush apparatus, the detection portion comprising detection components that react with ceria.

16. The brush cleaning method of claim 15, wherein the sensing of the color change comprises:
irradiating a beam to the brush apparatus through an optical window disposed on a side of the cleaning portion by a light source disposed in the cleaning apparatus;
reflecting, by the brush apparatus, the beam passed through the optical window and irradiated toward the brush apparatus, and re-entering the optical window; and
measuring a spectrum of the re-entered beam by a spectroscope disposed in the cleaning apparatus.

17. The brush cleaning method of claim 16, further comprising:
analyzing a degree of contamination of the brush apparatus due to the ceria based on a measurement result of the spectroscope.

18. The brush cleaning method of claim 15, wherein the sensing of the color change comprises:
detecting that a red Bphen-Fe²⁺ component of the detection portion is changed to white Bphen-Fe³⁺ due to the ceria absorbed by the brush apparatus.

19. The brush cleaning method of claim 15, wherein the cleaning of the brush apparatus comprises:
rotating the brush apparatus around a core portion disposed at a center of the brush apparatus; and
supplying a cleaning solution toward the brush apparatus by a cleaning solution supply portion.

20. The brush cleaning method of claim 19, wherein the detection portion comprises a dye, and
wherein the sensing of the color change comprises:
generating an OH radical by Ce³⁺ attached to the brush apparatus reacting with H₂O₂ comprised in the cleaning solution and changing to Ce⁴⁺; and
decomposing the dye by the OH radical and changing a color of the detection portion to white.
